(19) United States
(12) Patent Application Publication
(10) Pub. No.: US 2013/0326886 A1
(43) Pub. Date: Dec. 12, 2013

(54) REPLACEABLE HIGH GRIP CONNECTION FOR BLADE HOUSING OF ROTARY KNIFE

(71) Applicant: Clark A. Levsen, Shawnee, KS (US)

(72) Inventor: Clark A. Levsen, Shawnee, KS (US)

(73) Assignee: HANTOVER, INC., Kansas City, MO (US)

(21) Appl. No.: 13/494,755

(22) Filed: Jun. 12, 2012

(51) Int. Cl. B26B 25/00; B05D 3/12; B05D 7/14; A22C 17/04; B23P 6/00

(52) U.S. Cl. 30/276; 30/278; 30/340; 29/402.04; 427/142

(57) ABSTRACT

A rotary knife includes a handle, a rotatable annular blade, an expandle blade housing, and a housing support. The blade housing is movable relative to the handle between a blade-securing condition, in which the blade housing securely supports the blade for rotational operation, and a relatively expanded blade-releasing condition, in which the blade housing permits removal and installation of the blade relative to the blade housing. The housing support is coupled to the handle and supports the housing in the blade-securing and blade-releasing conditions. The support and housing include interengaging surfaces that contact one another in the blade-securing condition, with at least one of the interengaging surfaces including an applied high-friction coating.

### BACKGROUND

1. Field

The present invention relates generally to powered knives, such as those commonly used in meat processing plants. More specifically, embodiments of the present invention concern a rotary knife with a blade housing having a high-grip connection.

2. Discussion of Prior Art

Powered rotary knives that are used in the meat processing industry for dressing an animal carcass are known in the art. The process of dressing the carcass normally involves the removal of meat and fat from various bones as well as cutting various bones. Powered rotary knives enable workers to perform this process with great efficiency.

Turning to FIGS. 1-4, one such prior art rotary knife K includes a handle H, a blade housing BH, an annular blade B, a pinion housing PH, and a pinion cover C. The blade B is rotatably supported by the blade housing BH. As is customary, the blade housing BH is releasably clamped between the pinion housing PH and pinion cover C. The blade housing BH and pinion cover C each present grooved surfaces S that frictionally engage one another when the blade housing BH is clamped into position. The frictional engagement between grooved surfaces S restricts relative movement between the blade housing BH and the pinion cover C when the blade housing BH is secured. Reliable securement of the blade housing BH is important to maintain uniform and smooth rotating engagement between the blade B and blade housing BH. Movement of the blade housing BH relative to pinion cover C out of the secured position can cause excessive wear and/or malfunction of the blade housing BH, blade B, or both.

It has been found that prior art rotary knives suffer from certain deficiencies. For instance, the high-speed rotational movement of the annular blade, which is ideal for quickly and efficiently processing meat, causes the cutting edge of the annular blade to quickly become dull and require frequent sharpening or replacement. As a result, conventional rotary knives suffer from problems associated with knife maintenance. For example, the grooved surfaces S can become worn over time so as to lose frictional engagement (e.g., due to repeated knife assembly and disassembly for blade sharpening and replacement and/or due to the blade housing being too loosely or firmly clamped into the operating position). Thus, because the illustrated frictional connection provided by grooved surfaces S between the blade housing BH and pinion cover C is prone to wear, such wear can result in unintended relative movement between the blade housing BH and pinion cover C that causes excessive wear and/or malfunction of the blade housing BH, blade B, or both.

### SUMMARY

The following brief summary is provided to indicate the nature of the subject matter disclosed herein. While certain aspects of the present invention are described below, the summary is not intended to limit the scope of the present invention.

Embodiments of the present invention provide a rotary knife that does not suffer from the problems and limitations of the prior art knives set forth above.

A first aspect of the present invention concerns a rotary knife that broadly includes a handle, a rotatable annular blade, an expandable blade housing, and a housing support. The expandable blade housing is configured to removably support the blade. The blade housing is movable relative to the handle between a blade-securing condition, in which the blade housing securely supports the blade for rotational operation, and a relatively expanded blade-releasing condition, in which the blade housing permits removal and installation of the blade relative to the blade housing. The housing support is coupled to the handle and supports the housing on the handle in the blade-securing and blade-releasing conditions. The support and housing include interengaging surfaces that contact one another when the housing is in the blade-securing condition, with at least one of the interengaging surfaces including an applied high-friction coating so as to enhance frictional engagement between the housing and support and thereby restrict inadvertent expansion of the housing to the blade-releasing condition.

A second aspect of the present invention concerns a pinion cover for a rotary knife, wherein the knife includes a rotatable annular blade removably supported by an expandable housing that is at least in part clamped between the pinion cover and a pinion housing member to releasably retain the housing in a blade-securing condition. The pinion cover broadly includes a generally arcuately shaped body. The body presents a radially outwardly facing clamping face that is configured to be in an opposing relationship with the pinion housing. The clamping face is configured to contact at least a portion of the housing. The clamping face includes an applied high-friction coating so as to enhance frictional engagement with the at least a portion of the housing and thereby restrict inadvertent expansion of the housing out of the blade-releasing condition.

A third aspect of the present invention concerns a method of refurbishing a rotary knife, wherein the knife includes a rotatable annular blade removably supported by an expandable housing element that is at least in part clamped between clamping elements to releasably retain the housing element in a blade-securing condition, with each clamping element cooperating with the housing element to define interengaging surfaces that contact one another when the housing element is in the blade-securing condition. The knife refurbishing method broadly includes the steps of preparing at least one of the elements to receive a high-friction coating thereon; and applying a high-friction coating to the at least one of the elements such that the high-friction coating at least partly defines the corresponding interengaging surface, with the high-friction coating serving to enhance frictional engagement between the elements and thereby restrict inadvertent expansion of the housing out of the blade-securing condition.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is an upper perspective of a prior art rotary knife including a handle, a blade housing, an annular blade rotatably mounted in the blade housing, and a housing support that secures the blade housing to the handle, with the housing support including a pinion housing and a pinion cover;

FIG. 2 is a fragmentary cross section of the prior art rotary knife taken along line 2-2 in FIG. 1, showing a radially inwardly facing engagement surface of the blade housing and a radially outwardly facing engagement surface of the pinion cover, with the engagement surfaces each presenting a plurality of spaced apart grooves to enhance frictional engagement between the surfaces;

FIG. 3 is an enlarged fragmentary perspective of the pinion cover shown in FIGS. 1 and 2, showing the grooved engagement surface of the pinion cover;

FIG. 4 is an enlarged fragmentary perspective of the blade housing shown in FIGS. 1 and 2, showing the grooved engagement surface of the blade housing;

FIG. 5 is an upper perspective of a rotary knife constructed in accordance with a preferred embodiment of the present invention, with the rotary knife including a handle, a blade housing, an annular blade rotatably mounted in the blade housing, and a housing support that secures the blade housing to the handle, with the housing support including a pinion housing and a pinion cover;

FIG. 6 is a fragmentary cross section taken along line 6-6 in FIG. 5, showing a radially inwardly facing surface of the blade housing and a radially outwardly facing surface of the pinion cover each including a high-friction coating applied to the underlying substrate, with the surfaces being in frictional engagement with one another;

FIG. 7 is an exploded fragmentary perspective of the rotary knife shown in FIGS. 5 and 6;

FIG. 8 is an exploded fragmentary perspective of the rotary knife similar to FIG. 7 but taken from an opposite side of the knife;

FIG. 9 is an enlarged fragmentary perspective of the pinion cover shown in FIGS. 5-8, showing the high-friction coating of the pinion cover; and

FIG. 10 is an enlarged fragmentary perspective of the blade housing shown in FIGS. 5-8, showing the high-friction coating of the blade housing.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

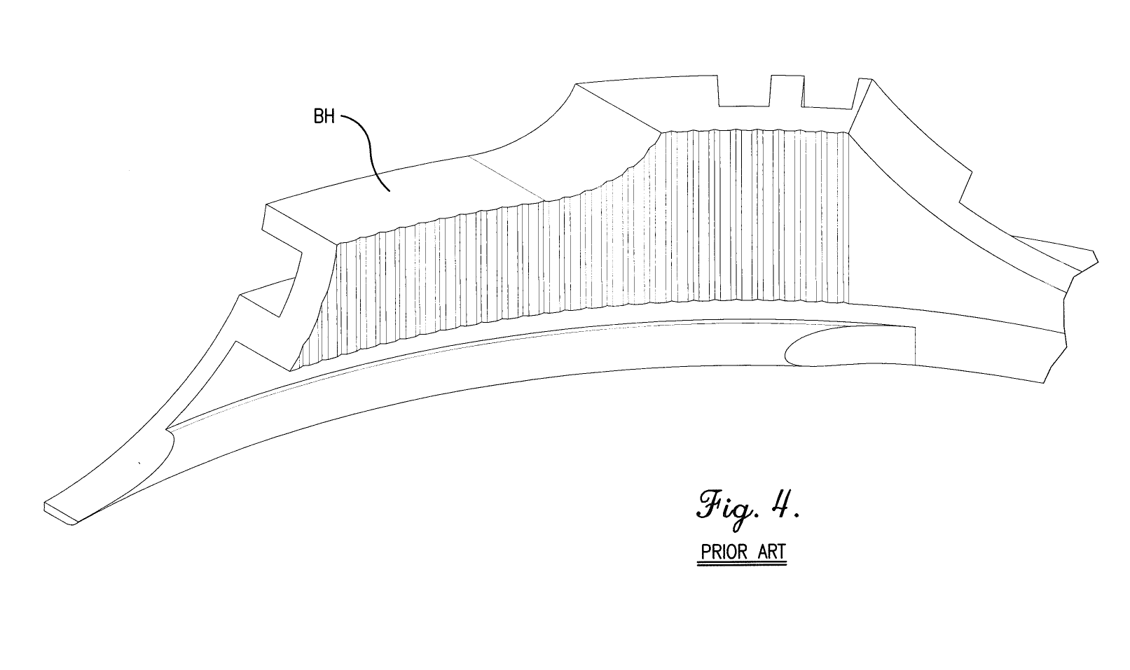

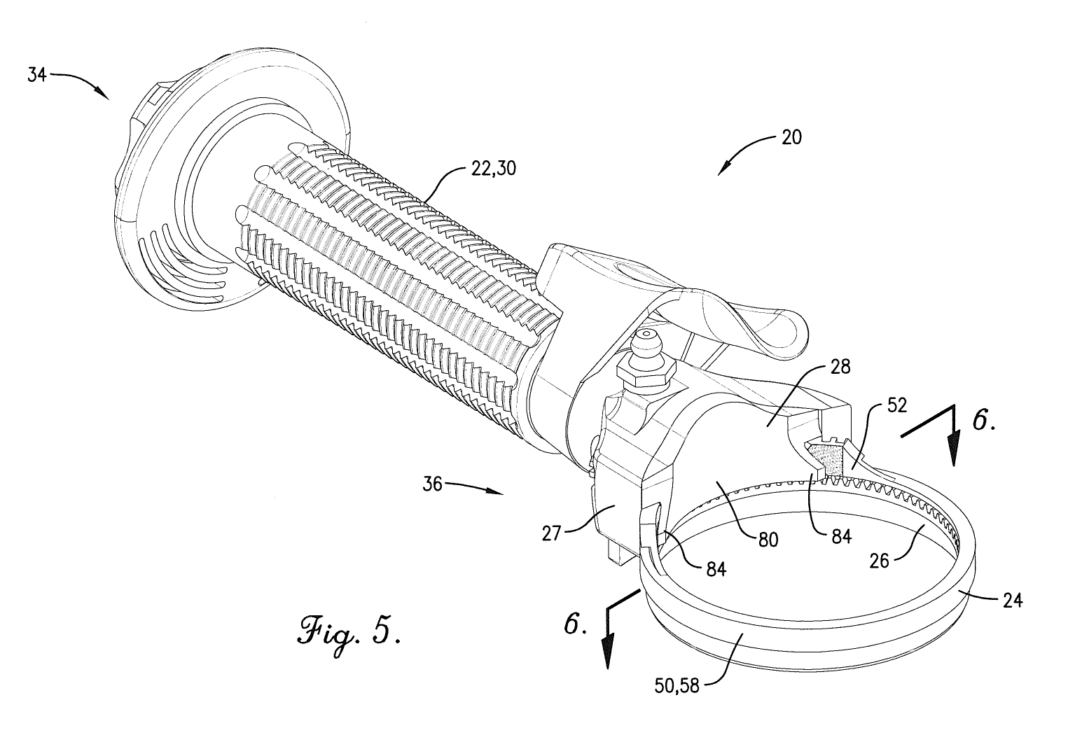

Turning initially to FIG. 5, a rotary knife 20 is constructed in accordance with a preferred embodiment of the present invention. The illustrated rotary knife 20 is particularly well suited for use in meat processing facilities, although other knife applications are entirely within the ambit of the present invention. The illustrated rotary knife 20 is preferably pneumatically powered by a pressurized air source (not shown), e.g., an air compressor. However, the principles of the present invention are equally applicable where the rotary knife is driven by alternative external power sources, such as sources that transmit power through hydraulic power or electrical power. The rotary knife 20 broadly includes a handle 22, an expandable split blade housing 24, a rotating annular blade 26, a pinion housing 27, and a pinion cover 28.

The handle 22 includes a grip housing 30. The grip housing 30 has a generally cylindrical shape and extends between a proximal connector end 34 and a distal end 36. The proximal end 34 is configured for quick connection to a pneumatic supply (not shown) or alternative power source. The grip housing 30 further presents an internal passage that houses a pneumatic motor (not shown).

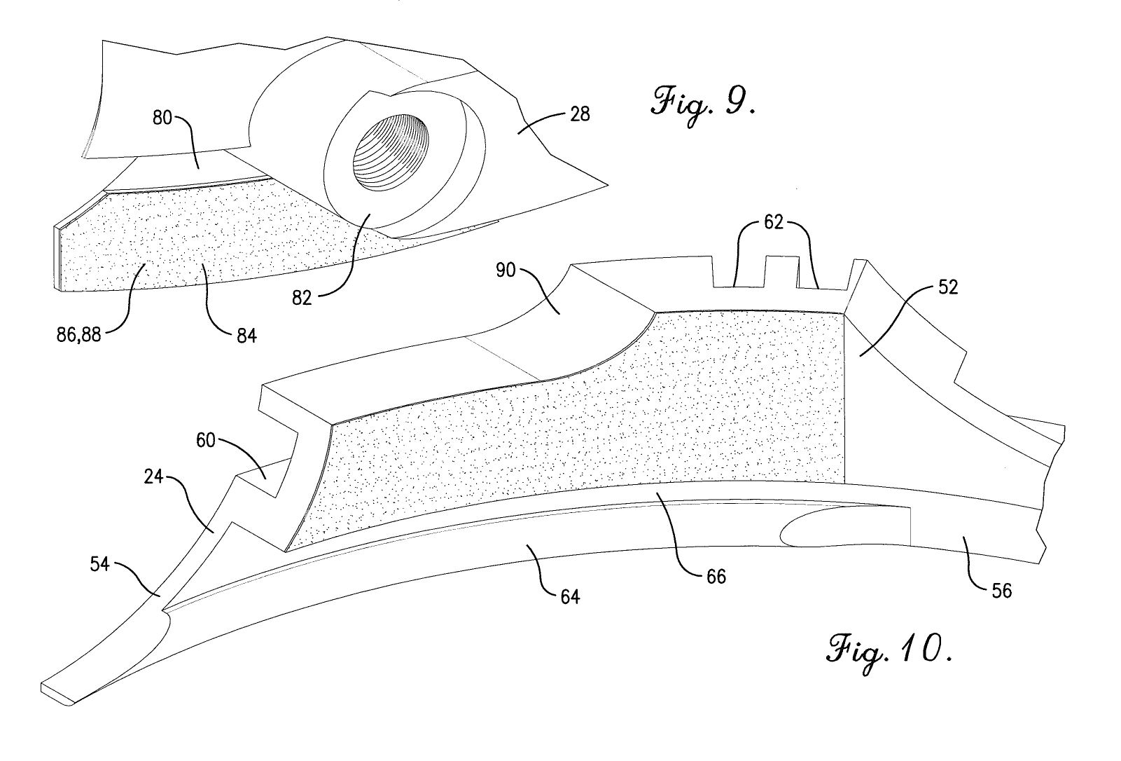

Turning to FIGS. 5-10, the pinion housing 27, pinion cover 28, and fasteners preferably cooperatively provide a housing support that supports the blade housing 24 relative to the handle 22. In particular, the pinion housing 27 and pinion cover 28 serve as clamping components that clamp and thereby support the blade housing 24. However, as will be described in greater detail, the illustrated housing support could be alternatively configured without departing from the scope of the present invention.

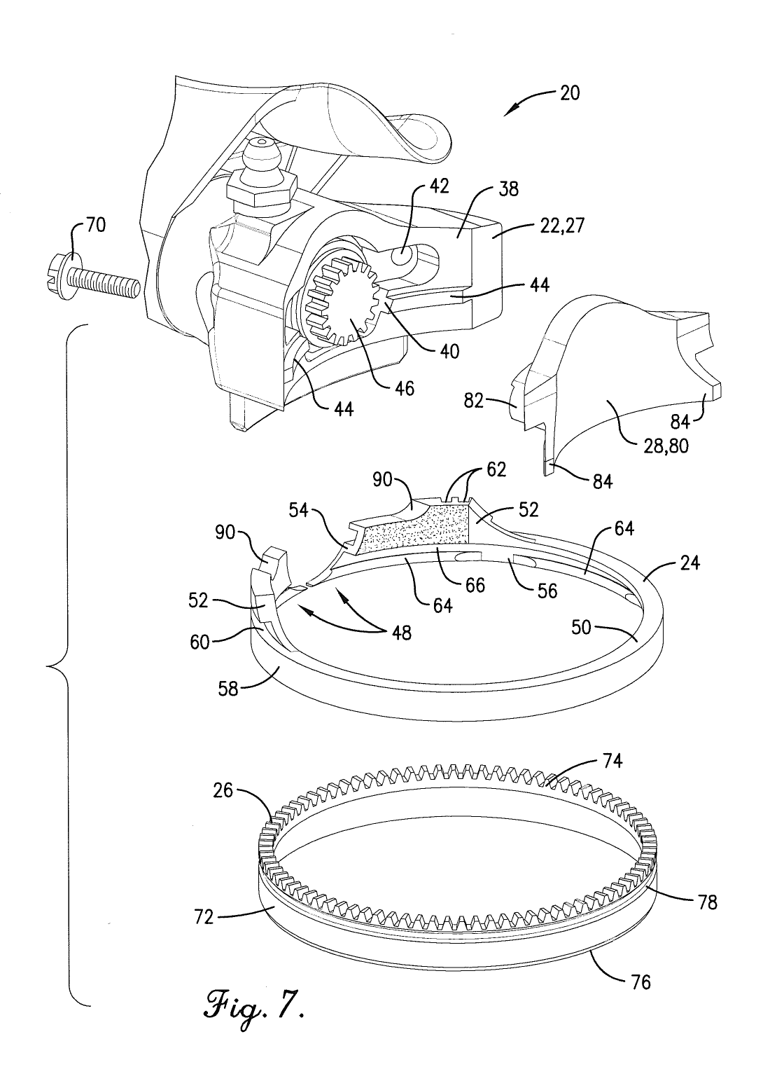

The pinion housing 27 is preferably fixed to the grip housing 30 at the distal end 36 and includes an arcuate clamping surface 38, a pinion-receiving socket 40, and holes 42. The arcuate clamping surface 38 defines a laterally extending rib 44 for positioning the blade housing 24, as will be discussed (see FIG. 7). The socket 40 is sized to receive and permit rotation of a drive pinion 46. The drive pinion 46 is interconnected with and is rotatably powered by the pneumatic motor.

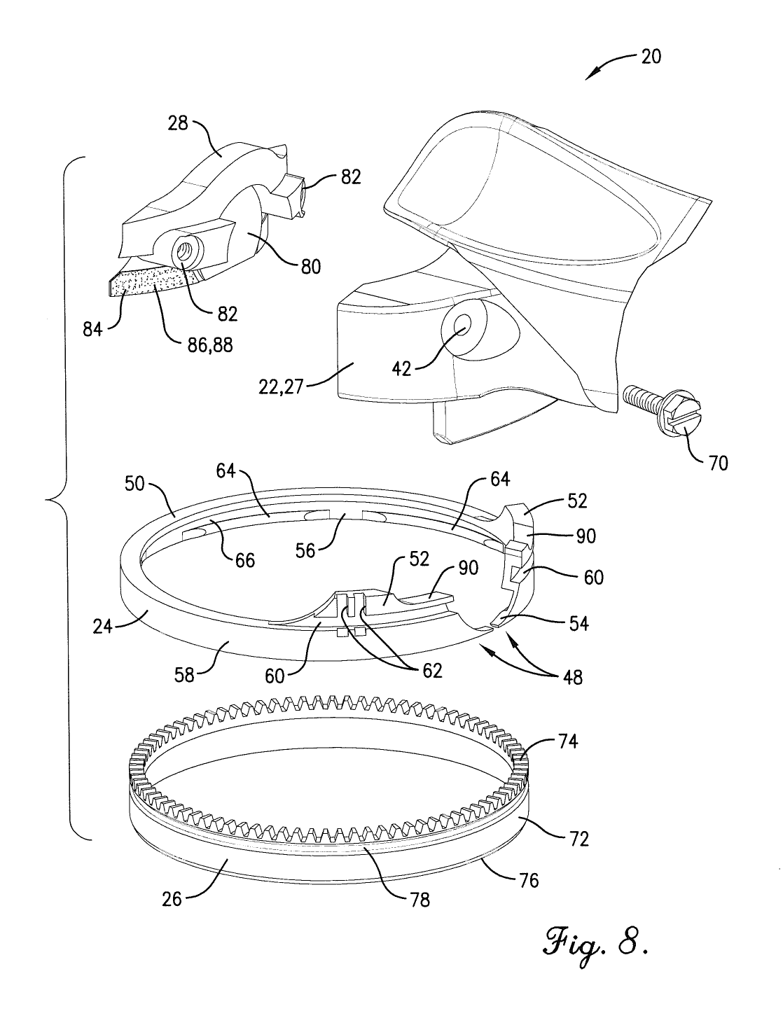

The expandable split blade housing 24 is substantially unitary and can be flexed so as to expand and contract between a blade-securing condition and a relative expanded blade-releasing condition. The blade housing 24 is annular and includes adjacent ends 48, an annular ring 50, and a flange 52. The blade housing 24 preferably presents a pinion-receiving opening 54 defined between the ends 48. The blade housing 24 also preferably presents arcuate inner and outer housing surfaces 56,58, with the outer housing surface 58 facing in a radially outward direction and the inner housing surface 56 facing oppositely to the outer housing surface 58 in a radially inward direction. The arcuate outer housing surface 58 defines a circumferential outer housing groove 60 that generally extends laterally along the flange 52. The outer housing surface 58 also presents axial slots 62 (see FIG. 8). The inner housing surface 44 defines circumferential rib segments 64 and a circumferential inner housing groove 66 (see FIGS. 7 and 8). The inner housing groove 66 serves as a race for rotatably supporting the blade 26 as will be discussed. Between the ends 48, the inner housing groove 66 extends substantially along the perimeter of the ring 50.

While the illustrated blade housing 24 preferably includes the single inner housing groove 66, it is consistent with the principles of the present invention for the blade housing 24 to include an alternative groove configuration for rotatably supporting the blade 26, e.g., an alternative number of grooves or an alternative groove shape. Preferred features of such alternative blade housing and groove constructions are disclosed in U.S. Pat. No. 8,037,611, issued Oct. 18, 2011, entitled ROTARY KNIFE WITH BLADE BUSHING, and U.S. application Ser. No. 13/283,324, filed Oct. 27, 2011, entitled ROTARY KNIFE WITH MECHANISM FOR CONTROLLING BLADE HOUSING, both of which are incorporated in their entirety by reference herein.

The handle 22, blade housing 24, pinion housing 27, and pinion cover 28 are preferably manufactured from a tempered steel to resist oxidation and corrosion within the adverse environment of a slaughterhouse. However, the principles of the present invention are equally applicable where the handle 22, blade housing 24, pinion housing 27, and pinion cover 28 include other metallic or non-metallic materials such as brass, aluminum, or stainless steel.

In the illustrated embodiment, the blade housing 24 also preferably includes a high-friction coating 68 applied to the substrate housing material along the flange 52. Preferably, the inner housing surface 56 of the blade housing 24 includes the coating 68. Also, the coating 68 is preferably a single material layer that is applied in sections adjacent to each end 48. As defined herein, a high-friction coating refers to a coating applied to the surface of a substrate (e.g., where the coating is adhered to the substrate surface) so that when the combined substrate and coating frictionally engages another surface, the resulting coefficient of friction is greater than the coefficient of friction associated with frictional engagement between the substrate surface and the another surface. As will be discussed, the coating 68 is most preferably designed to frictionally engage another coating applied to the pinion cover 28.

It is also within the scope of the present invention where the blade housing 24 includes, either entirely or partly, an outermost material layer for other purposes, such as corrosion resistance, aesthetic qualities, or other performance requirements. For instance, the blade housing 24 could have a layer of brass, aluminum, or stainless steel that is suitable for surface-to-surface engagement with the blade 26. In this manner, such an outermost layer, whether coated, adhered, or otherwise secured onto the base material, may provide an optimal surface for low-friction bearing engagement with the blade 26.

The blade housing 24 is attached to the pinion housing 27 by arranging the outer housing surface 58 in engagement with the clamping surface 38 so that the ribs 44 are positioned within the outer housing groove 60 and the drive pinion 46 is aligned with the pinion-receiving opening 54. As will be discussed, the pinion cover 28 and fasteners 70 secure the blade housing 24 to the pinion housing 27 and permit adjustable clamping of the blade housing 24 between the pinion housing 27 and pinion cover 28.

Turning to FIGS. 7 and 8, the annular blade 26 is preferably unitary and is substantially continuous around its circumference. The blade 26 includes a blade wall 72 and a ring gear 74 extending from the blade wall 72 for mating with the drive pinion 46. The blade wall 72 presents a sharp cutting edge 76 and an arcuate outer blade groove 78. The blade 26 is preferably rotatably mounted in the blade housing 24 by positioning the rib segments 64 in sliding engagement within the outer blade groove 78.

If desired, the blade 26 may be alternatively configured to include other types of edges. For example, instead of the sharp edge 76, the blade 26 could alternatively include an abrasive edge (e.g., with a surface that is gritted), a bristled edge, or a brush-type shredding edge. Similar to the blade housing 24, it is consistent with the principles of the present invention for the blade 26 to include an alternative groove configuration, such as an alternative number of grooves or an alternative groove shape.

The blade 26 is preferably manufactured from tempered steel. However, similar to the handle 22, blade housing 24, pinion housing 27, and pinion cover 28, the principles of the present invention are applicable where the blade 26 includes other metallic or non-metallic materials, such as brass, aluminum, or stainless steel. Alternatively, the blade 26, either entirely or partly, may include an outermost layer of brass, aluminum, or stainless steel that is suitable for surface-to-surface engagement with the blade housing 24. In this manner, such an outermost layer, whether coated, adhered, or otherwise secured onto the base material, may provide an optimal surface for low-friction bearing engagement. However, the outermost layer may be included for other purposes, such as corrosion resistance, aesthetic qualities, or other performance requirements. It will also be appreciated that the blade 26 could be mounted within the blade housing 24 using an annular bushing to restrict wear of the blade 26 and/or blade housing 24. Embodiments of a rotary knife with preferred features of an annular blade bushing are disclosed in the above-incorporated '611 patent and '324 application.

The pinion cover 28 preferably includes a unitary body with a curved wall 80 and internally-threaded bosses 82 that are integrally formed with the wall 80. The wall 80 includes a pair of oppositely positioned tab ends 84. The pinion cover 28 also preferably includes a high-friction coating 86. The illustrated coating 86 is preferably a single material layer applied continuously from one tab end 84 to the other tab end 84. Thus, the pinion cover 28 presents a clamping surface 88 that faces in a radially outward direction and includes the coating 86.

The coatings 68,86 are preferably formed with a liquid epoxy and discrete aluminum oxide particles interspersed within the epoxy to provide a gritted coating surface. However, it is also within the scope of the present invention where an alternative coating is used, e.g., to provide a suitable coefficient of friction. For instance, an alternative synthetic resin could be used to form the coatings 68,86. Also, discrete grit particles made from an alternative material, such as silicon carbide or diamond, could be employed with the epoxy. For some aspects of the present invention, the coatings 68,86 could also be devoid of grit particles.

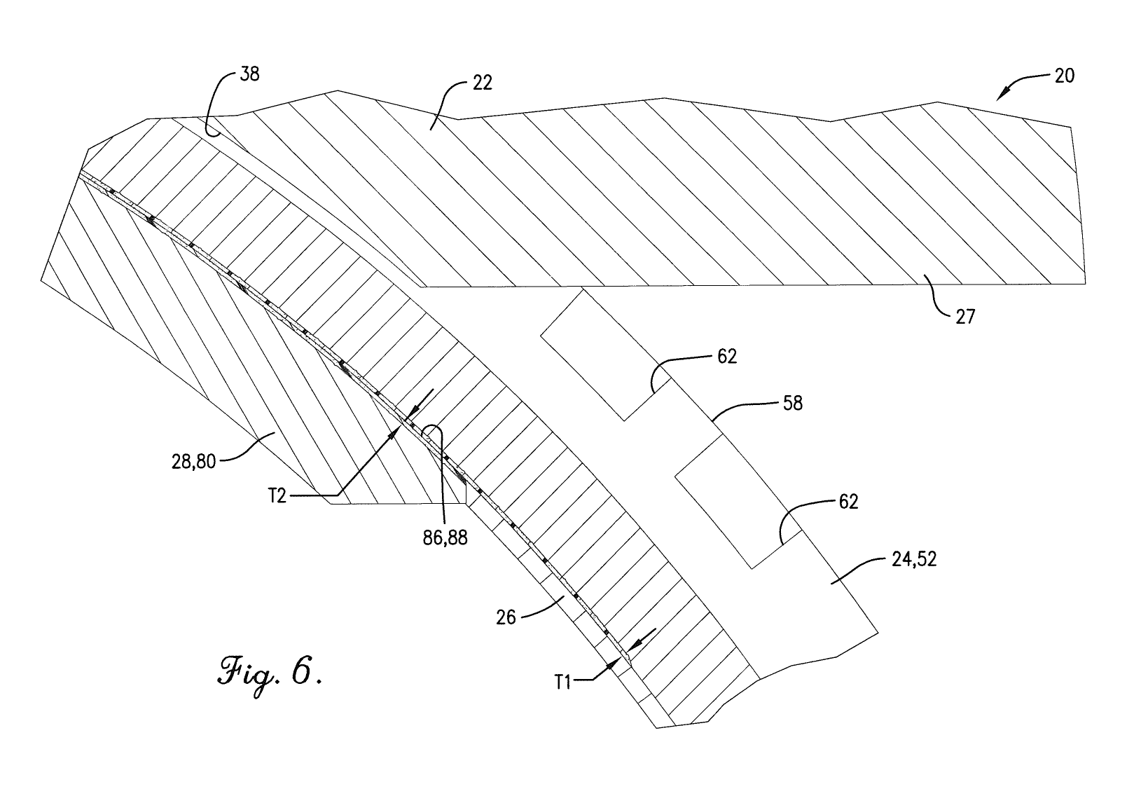

Again, the illustrated coatings 68,86 each preferably comprise a single layer of the combined epoxy and particles. However, it is within the ambit of the present invention where multiple layers of epoxy and particles are applied to form the coatings 68,86. For instance, it may be necessary to adjust the thickness dimensions T1,T2 of the coatings 68,86, e.g., where the thickness dimension T is increased to compensate for wear of the corresponding substrate (see FIG. 6). While the thickness dimensions T1,T2 are preferably substantially the same, the coatings 68,86 could have different thicknesses without departing from the scope of the present invention.

The coatings 68,86 are preferably applied to the respective underlying substrate. Prior to application of coatings 68,86, one or more steps are preferably required to prepare the substrate surface (e.g., so that adhesion is maximized between the substrate and coating). Preferably, the substrate surface is prepared by cleaning the surface (e.g., with a solvent), then abrading the surface, and then cleaning the abraded surface again. Preparation of the surface might also involve complete or partial removal of any previous coating layers. However, preparation of the substrate surface could involve just one of the foregoing steps. Furthermore, it will be appreciated that other preparatory steps could be required before coating application. The process of abrading the substrate surface is preferably done using sandpaper with a grit size that ranges from about one hundred (100) grit to about four hundred (400) grit. However, the substrate surface could be roughened by techniques other than abrasion, e.g., by etching the substrate surface, without departing from the scope of the present invention.

Application of coatings 68,86 is preferably done manually, although the principles of the present invention are applicable where a machine is employed to apply the coatings. For application of a single coating layer, the coating material is initially mixed. In particular, grit particles and epoxy are preferably mixed to provided the illustrated coating material. The mixed coating material is then applied to the prepared substrate surface in a coating layer. The applied coating layer is then allowed to set prior to use of the single coating layer and substrate.

To form the coatings 68,86 by applying multiple coating layers, coating material is mixed, a first coating layer is then applied to the prepared substrate surface, and the first applied coating layer is then allowed to set. Each subsequent coating layer is applied to the previous coating layer after the previous coating layer has set. Each subsequent coating layer is then allowed to set prior to application of another coating layer or use of the combined coating and underlying substrate.

Application of the high-friction coatings to the corresponding substrate is preferably intended to be performed as part of a knife refurbishment process, as will be described further. However, it is also within the scope of the present invention where the coatings are applied as part of the original knife component manufacturing process.

The pinion housing 27 and pinion cover 28 are shiftable relative to each other and preferably used to removably attach and support the blade housing 24 relative to the handle 22. In particular, fasteners 70 preferably extend through holes 42 in the pinion housing 27, along openings 90 presented by the flange 52, and are threaded into the threaded holes presented by the bosses 82 so that the blade housing 24 is clamped between the pinion cover 28 and the pinion housing 27. With the pinion housing 27 and pinion cover 28 holding the blade housing 24 in clamping engagement, further tightening of the fasteners 70 serves to increase the gripping force applied to the blade housing 24 by the pinion housing 27 and pinion cover 28.

Similarly, with the pinion housing 27 and pinion cover 28 in clamping engagement, loosening of the fasteners 70 serves to decrease the applied gripping force. Thus, the secured blade housing 24 can be disassembled from the knife 20 by loosening the fasteners 70 and shifting the pinion cover 28 away from the pinion housing 27. Such disengagement of the pinion housing 27 and pinion cover 28 permits removal of the blade housing 24 therefrom. Subsequently, the removed blade housing 24 can be selectively expanded from the blade-securing condition to the blade-releasing condition to permit removal of blade 26 from the blade housing 24.

Blade housing removal may accompany one or more of various knife maintenance procedures. For instance, blade housing removal may be followed by application of the illustrated coatings 68,86. Alternatively, blade housing removal may be followed by sharpening of the removed blade, followed by reinstallation of the sharpened blade. Yet further, blade housing removal could be followed by installation of another blade, such as an entirely new annular blade.

In any event, the blade to be installed in the knife 20 can be rotatably mounted in the expanded blade housing 24 following any application and setting of coatings 68,86. The blade is inserted by expanding the blade housing from the blade-securing condition to the blade-releasing condition, positioning the blade in rotatable engagement with the inner housing surface 56, and returning the blade housing 24 to the blade-securing condition. After blade insertion, the blade housing 24 can be secured between the pinion housing 27 and pinion cover 28. Securement of the blade housing 24 includes the steps of positioning the flange 52 between the pinion housing 27 and pinion cover 28, with the outer housing surface 58 adjacent the clamping surface 38 and the inner housing surface 56 adjacent the clamping surface 88. The fasteners 70 are then inserted through the pinion housing 27, threaded into the pinion cover 28, and tightened so as to clamp the blade housing 24 in place.

With the blade housing 24 secured relative to the handle 22, the clamping surface 38 of pinion housing 27 is preferably opposed to and interengaged with the outer housing surface 58. Also, the clamping surface 88 of pinion cover 28 is preferably opposed to and interengaged with the inner housing surface 56. Furthermore, the clamping surfaces 38,88 are preferably opposed to each other.

In this manner, the fasteners 70 hold the pinion housing 27 and pinion cover 28 in clamping engagement with the blade housing 24. However, for some aspects of the present invention, the pinion cover 28 could be constructed so as not to be used to secure the blade housing 24. For instance, the blade housing 24 could simply be secured to the pinion housing 27 with fasteners.

Preferably, the coatings 68,86 frictionally engage one another when the pinion housing 27 and pinion cover 28 are clamped to and secure the blade housing 24. Also, the pinion cover 28 preferably substantially covers the drive pinion 46 while permitting intermeshing engagement between the drive pinion 46 and the blade 26.

While the knife 20 is preferably constructed so that the pinion cover 28 is separate from the blade housing 24, it is also within the scope of the present invention where the pinion cover 28 is provided as part of the blade housing 24 and/or pinion housing 27.

The illustrated knife 20 preferably includes both of the illustrated coatings 68,86 so that the coatings 68,86 cooperatively provide a high coefficient of friction between the pinion cover 28 and blade housing 24. However, for some aspects of the present invention, the knife 20 could be provided with only one of the coatings 68,86. For example, the knife 20 could have only the coating 86 on the pinion cover 28, with the coating 86 being in frictional engagement with the substrate of the flange 52.

It is also within the ambit of the present invention where the coatings 68,86 are alternatively positioned to frictionally hold the blade housing 24 in the desired position. For instance, the coatings 68,86 could be applied to the pinion housing 27 to define at least part of the curved clamping surface 38 and to the blade housing 24 to define at least part of the outer housing surface 58. In this manner, the coatings 68,86 could provide direct frictional engagement between the blade housing 24 and the pinion housing 27. Also, the clamping surfaces 38,88 and housing surfaces 56,58 could all include coatings to provide additional frictional engagement.

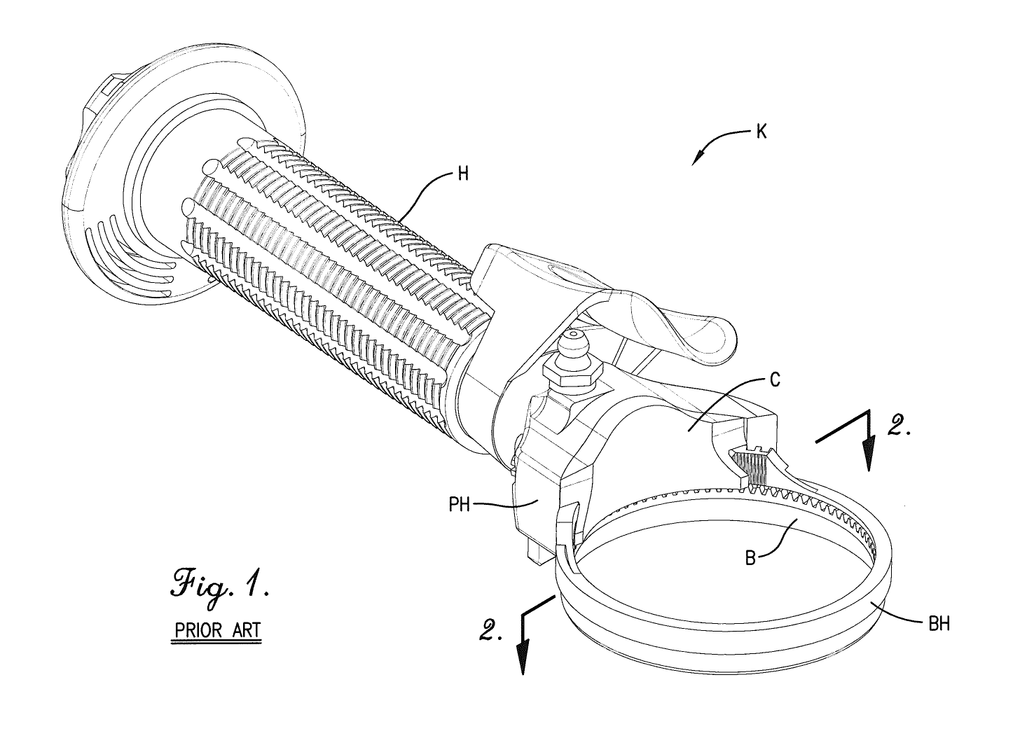

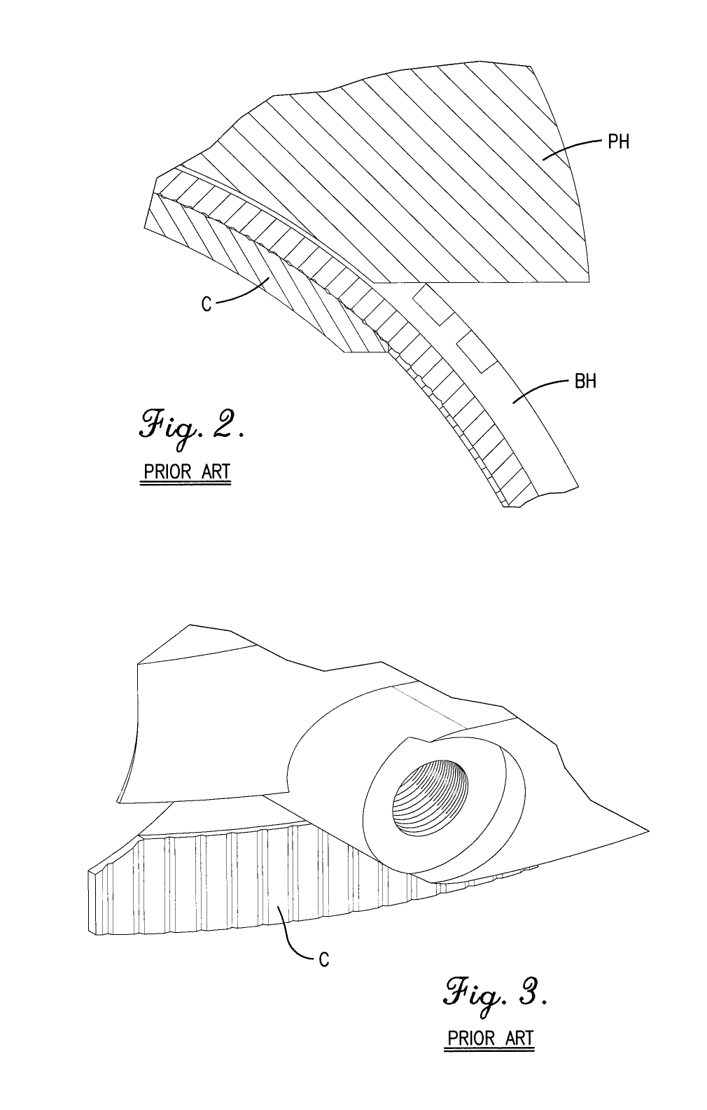

In operation, the knife 20 is preferably maintained by periodic refurbishment of interengaging surfaces of the pinion housing 27 and the blade housing 24. It is to be understood that knife refurbishment can involve not only re-coating of a surface that has previously been provided with the coating material but also newly applying the coating material to a new or used knife component. For example, the blade housing BH and pinion cover C of the knife K shown in FIGS. 1-4 may have one or more coating layers applied thereto once the grooved surfaces S have become worn. In any case, surface refurbishment is initiated by removing the blade housing 24 and blade 26 from the pinion housing 27. Removal of the blade housing 24 and blade 26 preferably exposes the clamping surfaces 38,88 and the inner and outer housing surfaces 56,58. Consequently, blade housing removal also serves to expose surfaces for application of coatings 68,86.

Prior to the coating application, knife refurbishment continues by preparing the underlying substrate surfaces of the blade housing 24 and pinion cover 28. As described, such preparation preferably involves a desired sequence of cleaning and abrading the surface. Coating material is then mixed and prepared. The mixed coating material is then applied to the prepared surfaces to form a coating layer. The coating layer is then allowed to set. Once the coatings are set, the blade housing 24 is secured to the handle 22 by the pinion housing 27 and the pinion cover 28 with fasteners 70.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A rotary knife comprising:
a handle;
a rotatable annular blade;
an expandable blade housing configured to removably support the blade, said blade housing being movable relative to the handle between a blade-securing condition, in which the blade housing securely supports the blade for rotational operation, and a relatively expanded blade-releasing condition, in which the blade housing permits removal and installation of the blade relative to the blade housing; and
a housing support being coupled to the handle and supporting the housing on the handle in the blade-securing and blade-releasing conditions,
said support and housing including interengaging surfaces that contact one another when the housing is in the blade-securing condition, with at least one of the interengaging surfaces including an applied high-friction coating so as to enhance frictional engagement between the housing and support and thereby restrict inadvertent expansion of the housing to the blade-releasing condition.

2. The rotary knife as claimed in claim 1,
said housing support including a pair of clamping components between which at least a portion of the housing is clamped,
said at least a portion of the housing and at least one of the clamping components presenting the interengaging surfaces.

3. The rotary knife as claimed in claim 2,
said clamping components presenting opposed clamping faces between which the at least a portion of the housing is located,
said at least a portion of the housing presenting oppositely directed housing faces, each of which contacts a respective one of the clamping faces to define a corresponding pair of the interengaging surfaces.

4. The rotary knife as claimed in claim 3,
said interengaging surfaces being generally arcuate in shape.

5. The rotary knife as claimed in claim 2,
a first one of the clamping components being selectively shiftable relative to a second one of the clamping components, with shifting of the first clamping component relative to the second clamping component varying the gripping force applied on the housing by the clamping components.

6. The rotary knife as claimed in claim 5,
said clamping components cooperatively housing a drive pinion that drivingly engages the blade,
said second clamping component comprising a pinion housing member fixed to the handle,
said first clamping component comprising a pinion cover removably attached to the housing member.

7. The rotary knife as claimed in claim 6,
said interengaging surface of the pinion cover including the high-friction coating.

8. The rotary knife as claimed in claim 7,
said pinion cover being arcuate in shape and presenting arcuately spaced opposite ends,
said high-friction coating extending continuously between the ends of the pinion cover.

9. The rotary knife as claimed in claim 1,
said high-friction coating comprising a mixture of adhesive and a particulate grit material.

10. The rotary knife as claimed in claim 9,
said adhesive comprising a synthetic resin.

11. The rotary knife as claimed in claim 9,
said particulate grit material being selected from the group consisting of aluminum oxide, silicon carbide, diamond, and combinations thereof.

12. A pinion cover for a rotary knife, wherein the knife includes a rotatable annular blade removably supported by an expandable housing that is at least in part clamped between the pinion cover and a pinion housing member to releasably retain the housing in a blade-securing condition, said pinion cover comprising:
a generally arcuately shaped body,
said body presenting a radially outwardly facing clamping face that is configured to be in an opposing relationship with the pinion housing,
said clamping face being configured to contact at least a portion of the housing,
said clamping face including an applied high-friction coating so as to enhance frictional engagement with the at least a portion of the housing and thereby restrict inadvertent expansion of the housing out of the blade-releasing condition.

13. The pinion cover as claimed in claim 12,
said pinion cover presenting arcuately spaced opposite ends,
said high-friction coating extending continuously between the ends of the pinion cover.

14. The pinion cover as claimed in claim 12,
said high-friction coating comprising a mixture of adhesive and a particulate grit material.

15. The pinion cover as claimed in claim 14,
said adhesive comprising a synthetic resin.

16. The pinion cover as claimed in claim 14,
said particulate grit material being selected from the group consisting of aluminum oxide, silicon carbide, diamond, and combinations thereof.

17. The pinion cover as claimed in claim 12,
said body being abraded prior to application of the high-friction coating.

18. A method of refurbishing a rotary knife, wherein the knife includes a rotatable annular blade removably supported by an expandable housing element that is at least in part clamped between clamping elements to releasably retain the housing element in a blade-securing condition, with each clamping element cooperating with the housing element to define interengaging surfaces that contact one another when the housing element is in the blade-securing condition, said knife refurbishing method comprising the steps of:
(a) preparing at least one of the elements to receive a high-friction coating thereon; and
(b) applying a high-friction coating to the at least one of the elements such that the high-friction coating at least partly defines the corresponding interengaging surface, with the high-friction coating serving to enhance frictional engagement between the elements and thereby restrict inadvertent expansion of the housing out of the blade-securing condition.

19. The knife refurbishing method as claimed in claim 18,
step (a) including the step of roughening the at least one of the elements along an underlying surface upon which the high-friction coating is applied.

20. The knife refurbishing method as claimed in claim 19,
step (a) including the step of abrading the underlying surface with sandpaper having a grit size that ranges from about 100 grit to 400 grit.

21. The knife refurbishing method as claimed in claim 20,
step (a) including the step of cleaning the underlying surface after the underlying surface has been abraded.

22. The knife refurbishing method as claimed in claim 19,
step (a) being completed before step (b) is performed.

23. The knife refurbishing method as claimed in claim 18; and
(c) before step (b), mixing the high-friction coating.

24. The knife refurbishing method as claimed in claim 23,
step (c) including the step of combining particulate grit material and an adhesive.

25. The knife refurbishing method as claimed in claim 18,
step (b) including the step of allowing the coating to set.

26. The knife refurbishing method as claimed in claim 25,
step (b) being repeated so that multiple layers of high-friction coating are applied.

27. The knife refurbishing method as claimed in claim 18,
steps (a) and (b) being performed manually.

28. The knife refurbishing method as claimed in claim 18; and
(c) disassembling the knife by shifting the clamping elements away from one another so that the housing element is no longer clamped between the clamping elements and the interengaging surface of the at least one of the elements is exposed,
performing steps (a) and (b) after step (c).

29. The knife refurbishing method as claimed in claim 28; and
(d) after steps (a) and (b), reassembling the knife by clamping the housing element at least in part between the clamping elements.
